(19) United States
(12) Patent Application Publication
(10) Pub. No.: US 2021/0072092 A1
(43) Pub. Date: Mar. 11, 2021

(54) TEMPERATURE MEASURING DEVICE AND ELECTRIC POWER SYSTEM

(71) Applicant: FATRI (Xiamen) Technologies, Co., Ltd., Xiamen City (CN)

(72) Inventors: Yongzhong Nie, Xiamen City (CN); Wenjian Yang, Xiamen City (CN); Jianwei Chen, Xiamen City (CN)

(21) Appl. No.: 16/729,662

(22) Filed: Dec. 30, 2019

(30) Foreign Application Priority Data
Sep. 5, 2019 (CN) 201910839756.8

(51) Int. Cl. G01K 1/14; G01K 1/16; H02B 1/48

(52) U.S. Cl. CPC G01K 1/14; H02B 1/48; G01K 1/16

(57) ABSTRACT

The application relates to the technical field of temperature measurement, in particular to a temperature measuring device and an electric power system. The temperature measuring device is used for measuring a temperature of a heat generating member provided with a convex portion or a groove portion, and comprises a heat conducting block 1 for receiving the convex portion or extending into the groove portion, being connected with the convex portion or the groove portion; and a thermo-sensitive element 2 connected with the heating conducting block 1. The temperature measuring device of the present application has advantages of high sensitivity and being installed and disassembled without power failure.

### CROSS REFERENCE TO RELATED APPLICATIONS

This application claims priority to Chinese Patent Application No. 201910839756.8, filed on Sep. 5, 2019, the entire contents of which are incorporated herein by reference.

### TECHNICAL FIELD

The application relates to the technical field of temperature measurement, in particular to a temperature measuring device and an electric power system.

### BACKGROUND

Material will age when it has a temperature above a safe temperature, which will cause damage to an equipment, or even danger. Therefore, it is usually used for temperature measurement in a place where has a high heat production or that is prone to high temperatures, such as in an electric power system.

In the daily operation of a substation equipment of the electric power system, the temperature of the substation equipment will change constantly with ambient temperature and load. At present, a method for measuring the temperature of the substation equipment is usually periodic infrared temperature measurement of maintenance personnel, which has large labor intensity and is unpredictable. Moreover, after a long time of use, the substation equipment is prone to defects of a hot spot. If the hot spot is missed during the temperature measurement, it may cause damage to the equipment and affect safe and stable operation of a power grid. Therefore, this problem has become a weak link of the power grid. The bolt connection area of busbars of the substation equipment is most likely to enter a vicious cycle of generating heat, oxidating, increasing resistance, and further generating heat, eventually causing an accident. The accidents caused by generating heat in this area account for the vast majority of the currently known accidents, and may cause enormous losses, so it is necessary to perform an automatic monitoring of the operating temperatures of connection area of these equipment.

At present, most of the devices used for temperature measurement in the power grid field, such as CT power take-off, are strap-type mounted structures, which require to be installed after the grid substation powered off. Once the strap-type product is damaged, it needs to be replaced by a power outage, which has a great impact on people's normal life and is not possible to be performed at any time. Therefore, the strap-type product is very inconvenient and has poor practical value. Moreover, the temperature measuring device is generally installed on the busbar, so the temperature at the connection area is indirectly measured by measuring the temperature on the busbar, having poor sensitivity to monitoring of dangerous temperature, so as to be not conducive to timely prevention of danger.

### SUMMARY

Therefore, the present application provides a temperature measuring device that is highly sensitive and can be replaced without power failure, and an electric power system installed with the temperature measuring device.

One objective of the present application is to provide a temperature measuring device for measuring a temperature of a heat generating member provided with a convex portion or a groove portion, comprising a heat conducting block for receiving the convex portion or extending into the groove portion, being connected with the convex portion or the groove portion; and a thermo-sensitive element connected with the heating conducting block.

Preferably, the temperature measuring device and the heat generating member are in plug connection or threaded connection with the convex portion or the groove portion through the heat conducting block.

Preferably, the heat generating member is a connecting member connecting two conductors and having a convex portion at one end, and the heat conducting block is provided with a receiving cavity for receiving the convex portion.

Preferably, the connecting member is a bolt, and the receiving cavity is provided with an inner thread on a cavity wall thereof.

Preferably, the temperature measuring device further comprises a casing disposed outside of the temperature measuring device and having a non-circular outer contour.

Preferably, the outer contour of the casing is hexagonal prismatic

Preferably, the heat conducting block is provided with a mounting hole on an outer side wall thereof, and the thermo-sensitive element is mounted in the mounting hole and fixed to the mounting hole with glue.

Preferably, the temperature measuring device further comprises a casing, having a heat conducting block and a thermo-sensitive element mounted therein; an upper cap, being in threaded connection with an upper end of the casing; and a waterproof gasket, disposed between the casing and the upper cap.

Preferably, the temperature measuring device further comprises a monitor; a heat insulating sleeve, disposed in the casing and having a power source and a circuit board disposed on an inner side thereof; and a wire, mounted between the heat insulating sleeve and the casing, for connecting the heat sensitive element and the circuit board; wherein, the circuit board is remotely connected with the monitor.

Another objective of the present application is to provide an electric power system, comprising the above temperature measuring device.

The technical solution of the present application has the following advantages.

1. The temperature measuring device provided in the present application is used for measuring a temperature of a heat generating member provided with a convex portion or a groove portion. The temperature measuring device comprises: a heat conducting block for receiving the convex portion or extending into the groove portion, being connected with the convex portion or the groove portion, so that the heat conducting block is more closely contacted with the heat generating member, reducing heat loss caused by heat transfer, thereby the temperature measurement is more sensitive and has a better effect; and a thermo-sensitive element connected with the heating conducting block.

2. The temperature measuring device provided in the present application and the heat generating member are in plug connection or threaded connection with the convex portion or the groove portion through the heat conducting block. The temperature measuring device and the heat generating member are connected in a simple manner, which does not require more connection points, and are convenient to install and disassemble.

3. In the electric power system, the temperature measuring device in the present application has many connection points between conductors through the connecting member. The conductor and the connecting member will constantly change over ambient temperature and load, and will age after a long time of use, which will lead to an increase in heat generation. In particular, the connecting member, used as a connection point, is most likely to enter a vicious cycle of generating heat, oxidating, increasing resistance, and further generating heat, since all the electricity passes through the connecting member having a relatively small cross-section of the conductor. The convex portion of the heat generating member is screwed connected with the heat conducting block, so that the heat conducting block contacts more closely with the heat generating member, reducing heat loss caused by heat transfer, thereby the temperature measurement is more sensitive. Meanwhile, this connection mode is simple, and there is no need to install and disassemble in the event of power failure during the installation and disassembly process. Therefore, the temperature measuring device of this application has a wider application range and is suitable for popularization and application.

4. In the temperature measuring device provided in the present application, the casing has a non-circular outer contour, so that the temperature measuring device can be installed and disassembled remotely using a special tool. That is to say, when the outer contour of the casing is hexagonal prismatic, the temperature measuring device can be installed and disassembled remotely using a wrench or a sleeve.

### BRIEF DESCRIPTION OF THE DRAWING

One or more embodiments are illustrated by way of example, and not by limitation, in the figures of the accompanying drawings, wherein elements having the same reference numeral designations represent like elements throughout. The drawings are not to scale, unless otherwise disclosed.

In order to more clearly illustrate the technical solutions of the embodiments of the present application or the prior art, the drawings used in the embodiments of the present application or the prior art will be briefly described below. Obviously, the drawings in the following description are only some embodiments of the present application, and those skilled in the art can obtain other drawings based on these drawings without any creative efforts.

FIG. 1 is a schematic view showing an exploded view of the temperature measuring device of the present application.

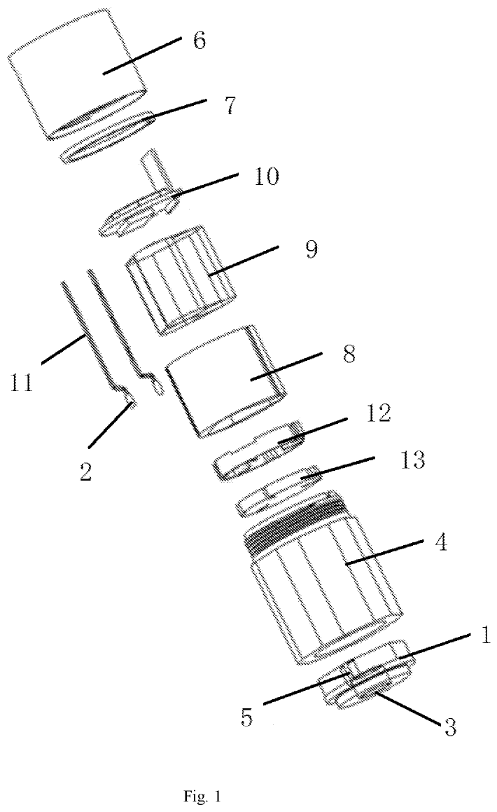

In the drawings, the reference numerals are:
1—heat conducting block; 2—thermo-sensitive element; 3—inner thread; 4—casing; 5—mounting hole; 6—upper cap; 7—waterproof gasket; 8—heat insulating sleeve; 9—power source; 10—circuit board; 11—wire; 12—support frame; 13—insulation ring.

### DETAILED DESCRIPTION

The technical solutions of the present application will be described clearly and completely with reference to the accompanying drawings. It is obvious that the described embodiments are only a part of the embodiments of the present application, and not all of the embodiments. All other embodiments obtained by those skilled in the art based on the embodiments of the present application without any creative efforts are within the scope of the present application.

In the description of the present application, it should be noted that the terms “installed”, “linked”, and “connected” are to be understood broadly, unless otherwise clearly stipulated and defined, and may be, for example, fixedly connected, detachably connected, or integrally connected; mechanically connected or electrically connected; directly connected or indirectly connected through an intermediate medium, and may be internal communication between the two elements. The specific meanings of the above terms in the present application may be understood by those skilled in the art based on a particular case.

Further, the technical features involved in the different embodiments of the present application described below may be combined with each other as long as they do not constitute a conflict with each other.

### Embodiment 1

Embodiment 1 provides a temperature measuring device for measuring a temperature of a heat generating member provided with a convex portion. The temperature measuring device comprises heat a conducting block 1, a thermo-sensitive element 2, a casing 4, an upper cap 6, a power source 9, a circuit board 10, a heat insulating sleeve 8 and a monitor.

The heat generating member is a connecting member connecting two conductors and has the convex portion at one end. In embodiment 1, the connecting member is a bolt connecting two conductors. The temperature measuring device and the heat generating member are in plug connection or threaded connection with the convex portion through the heat conducting block 1.

The heat conducting block 1 is provided with the receiving cavity on a portion corresponding to the convex portion, which extends into the receiving cavity. The receiving cavity is provided with an inner thread 3 on a cavity wall thereof. The heat conducting block 1 is provided with a mounting hole 5 on an outer side wall thereof, and the thermo-sensitive element 2 is mounted in the mounting hole 5 and fixed to the mounting hole 5 with glue, optionally a thermal glue, so that the thermo-sensitive element 2 is firmly fixed on the heat conducting block 1, reducing the heat loss during heat transfer.

The casing 4 is provided with the heat conducting block 1, the thermo-sensitive element 2, the power source 9, the circuit board 10 and the heat insulating sleeve 8. The casing 4 has a non-circular, such as quadrangular and hexagonal prismatic outer contour in order to facilitate installation and disassembly of the temperature measuring device remotely. When the outer contour is a hexagonal prismatic, the temperature measuring device can be installed and disassembled by using various components, such as open-end wrenches, adjustable wrenches, and sleeves. The upper cap 6 is in threaded connection with an upper end of the casing 4. In order to increase the waterproof performance of the temperature measuring device, a waterproof gasket 7 is disposed between the casing 4 and the upper cap 6.

The heat insulating sleeve 8 is disposed in the casing 4 and having the circuit board 10 and the power source 9 for powering the circuit board 10 disposed on an inner side thereof. A wire 11 is mounted between the heat insulating sleeve 8 and the casing 4, for connecting the heat sensitive element 2 and the circuit board 10. The circuit board 10 is located above the power source 9, and is remotely connected with the monitor, to send a signal containing temperature to the monitor for processing.

In order to prevent the heat generated by heat conduction block 1 from affecting the power source 9, an insulation ring 13 is disposed above the heat conducting block 1, and is provided with a support frame 12 thereabove, and the power source 9 is mounted on the support frame 12 disposed inside the heat insulating sleeve 8.

The heat conducting block 1 of the temperature measuring device is connected with the heat generating member, and the heat generated by the heat generating member is directly transmitted to the thermo-sensitive element 2 through the heat conducting block 1, and the signal measured by the thermo-sensitive element 2 is transmitted to the circuit board 10 via the wire 11, and then transmitted remotely from the circuit board 10 to the monitor, which monitors the heat generated by the heat generating member. The way to monitor the heat is simple and predictable.

In the temperature measuring device of embodiment 1, the heat conducting block 1 is directly connected with the heat generating member to reduce the loss and heat transfer time during the heat transfer process, thereby the measured temperature is more accurate and sensitive. Moreover, the temperature measuring device is screwed connected with the heat conducting member, this connection mode is simple, and there is no need to install and disassemble in the event of power failure during the installation and disassembly process. Therefore, the temperature measuring device of this application has a wider application range and is suitable for popularization and application.

### Embodiment 2

In embodiment 2, the heat generating member has a convex portion at one end, but no thread is provided on the convex portion. The temperature measuring device of embodiment 2 differs from that of embodiment 1 in that: an inner thread 3 is not disposed in the receiving cavity of the heat measuring block 1 of the temperature measuring device. The connecting member and the heat conducting block 1 are in plug connection with each other, and the plug connection can be the existing way of plug connection, such as a simple plug-in connection, or a plug connection using a buckle, but all of these plug connections have advantages of being able to be installed and disassembled remotely.

### Embodiment 3

In embodiment 3, the heat generating member has a groove. The temperature measuring device of embodiment 3 differs from that in embodiment 1 in that: the heat conducting block 1 has an insertion end inserted into the groove, and the temperature measuring device and the heat generating member are in plug connection or threaded connection with the groove portion through the insertion end. The temperature measuring device also has the advantage of being able to be installed and disassembled remotely.

### Embodiment 4

The electric power system of embodiment 4 has the temperature measuring device according to any one of embodiments 1 to 3.

It is apparent that the above embodiments are merely embodiments for clarity of illustration, and are not intended to limit the embodiments. Other variations or modifications of the various forms may be made by those skilled in the art in view of the above description. There is no need and no way to present all of the embodiments. The obvious variations or modifications derived therefrom are still within the scope of protection created by the present application.

What is claimed is:

1. A temperature measuring device for measuring a temperature of a heat generating member provided with a convex portion or a groove portion, comprising
a heat conducting block for receiving the convex portion or extending into the groove portion, being connected with the convex portion or the groove portion; and
a thermo-sensitive element connected with the heating conducting block.

2. The temperature measuring device according to claim 1, wherein, the temperature measuring device and the heat generating member are in plug connection or threaded connection with the convex portion or the groove portion through the heat conducting block.

3. The temperature measuring device according to claim 1, wherein, the heat generating member is a connecting member connecting two conductors and having a convex portion at one end, and the heat conducting block is provided with a receiving cavity for receiving the convex portion.

4. The temperature measuring device according to claim 3, wherein, the connecting member is a bolt, and the receiving cavity is provided with an inner thread on a cavity wall thereof.

5. The temperature measuring device according to claim 1, further comprising a casing disposed outside of the temperature measuring device and having a non-circular outer contour.

6. The temperature measuring device according to claim 5, wherein, the outer contour of the casing is hexagonal prismatic.

7. The temperature measuring device according to claim 1, wherein, the heat conducting block is provided with a mounting hole on an outer side wall thereof, and the thermo-sensitive element is mounted in the mounting hole and fixed to the mounting hole with glue.

8. The temperature measuring device according to claim 1, further comprising
a casing, having a heat conducting block and a thermo-sensitive element mounted therein;
an upper cap, being in threaded connection with an upper end of the casing; and
a waterproof gasket, disposed between the casing and the upper cap.

9. The temperature measuring device according to claim 8, further comprising
a monitor;
a heat insulating sleeve, disposed in the casing and having a power source and a circuit board disposed on an inner side thereof; and
a wire, mounted between the heat insulating sleeve and the casing, for connecting the heat sensitive element and the circuit board;
wherein, the circuit board is remotely connected with the monitor.

10. An electric power system, comprising the temperature measuring device according to claim 1.

11. The temperature measuring device according to claim 2, wherein, the heat generating member is a connecting member connecting two conductors and having a convex portion at one end, and the heat conducting block is provided with a receiving cavity for receiving the convex portion.

12. The temperature measuring device according to claim 2, further comprising a casing disposed outside of the temperature measuring device and having a non-circular outer contour.

13. The temperature measuring device according to claim 3, further comprising a casing disposed outside of the temperature measuring device and having a non-circular outer contour.

14. The temperature measuring device according to claim 4, further comprising a casing disposed outside of the temperature measuring device and having a non-circular outer contour.

15. The temperature measuring device according to claim 2, wherein, the heat conducting block is provided with a mounting hole on an outer side wall thereof, and the thermo-sensitive element is mounted in the mounting hole and fixed to the mounting hole with glue.

16. The temperature measuring device according to claim 3, wherein, the heat conducting block is provided with a mounting hole on an outer side wall thereof, and the thermo-sensitive element is mounted in the mounting hole and fixed to the mounting hole with glue.

17. The temperature measuring device according to claim 4, wherein, the heat conducting block is provided with a mounting hole on an outer side wall thereof, and the thermo-sensitive element is mounted in the mounting hole and fixed to the mounting hole with glue.

18. The temperature measuring device according to claim 2, further comprising
a casing, having a heat conducting block and a thermo-sensitive element mounted therein;
an upper cap, being in threaded connection with an upper end of the casing; and
a waterproof gasket, disposed between the casing and the upper cap.

19. The temperature measuring device according to claim 3, further comprising
a casing, having a heat conducting block and a thermo-sensitive element mounted therein;
an upper cap, being in threaded connection with an upper end of the casing; and
a waterproof gasket, disposed between the casing and the upper cap.

20. The temperature measuring device according to claim 4, further comprising
a casing, having a heat conducting block and a thermo-sensitive element mounted therein;
an upper cap, being in threaded connection with an upper end of the casing; and
a waterproof gasket, disposed between the casing and the upper cap.
